(19) United States
(12) Patent Application Publication
(10) Pub. No.: US 2012/0209617 A1
(43) Pub. Date: Aug. 16, 2012

(54) WEB SITE SYSTEM FOR CREATING UNIQUE WEB PAGES ON A LARGE SCALE

(76) Inventor: Jason Glen Trout, Decorah, IA (US)

(21) Appl. No.: 13/024,365

(22) Filed: Feb. 10, 2011

(51) Int. Cl. G06Q 99/00

(52) U.S. Cl. 705/1.1

(57) ABSTRACT

A method of using a computer which has a web site which includes a blogging platform where the blogging platform has a main page and an upcoming section; assembling together as a group written blog posts received; posting the group of received written blog posts to the upcoming section of the blogging platform on the computer; reviewing each blog post of the group of blog posts and rating each blog in the group for interest, relevancy, quality, etc.; promoting a selected number of the blog posts with the highest rating to the main page of the blogging platform on the computer; and paying each submitter of the blog post promoted to the main page when the blog post is promoted to the main page.

### BACKGROUND OF THE INVENTION

1. Field of the Invention

The present invention relates to using a computer community oriented system to provide a new, improved, and more economical method and systematic way of creating a vast amount of content oriented web pages for a website. By developing a website on a vast scale the objective of increasing the website's overall footprint on the internet will be achieved and website traffic will increase as well.

2. Description of Related Art

The expression that is well heard on the internet is that content is king. This means that the more content one has of original written material, the more visitors, advertising impressions, and revenue will be driven by said website. Content is the reason AOL paid $40 million to acquire TechCrunch, why Yahoo paid $100 million to acquire Associated Content, why The New York Times paid $410 million to acquire About.com, and why CBS paid $1.8 billion to acquire CNET in 2008. The need for original content on a vast scale is exemplified by these business deals and the money valuation that was assigned accordingly.

Yet, the problem with creating high quality content on the Internet is that it is very expensive to do so. You have to have a slew of writers on staff and editors to manage those writers.

TechCrunch, for example, has 25 paid bloggers on staff. There are first drafts, rewrites requested by the editor, and then final drafts. And even after all of that effort, the resulting content may not prove interesting to the sites visitors. The writer and editor are, after all, only two people trying to gauge what will interest tens of thousands of site visitors.

The single biggest factor that Google uses to determine search engine rankings is the number of incoming links to a site and that the site users will be generating these incoming links by the tens of thousands as they let their friends know about posts on social media services like Facebook and Twitter.

What is needed to achieve these impressive search engine rankings and vast content for a startup or existing website that has a limited staff and budget is a new, improved more economical method and system of creating a web page—this within a system that will then repeat the process over and over again so as to create thousands of pages that have interest to an end user that comes to the site for its content.

This new system as outlined herein is different from current systems by understanding features from current websites and knowing that they lack certain features therein.—issues such as compensation for website development and voting to promote content that will appeal to a mass audience over a select few.

Current systems in the market place include but are not limited to the following:

For example, Digg offers web content but there is no compensation for a user that reaches the home page. Members submit links to content, but do not generate new content on the site. This is different from the system described herein for it has compensation for reaching the homepage and content that is created on the site itself.

The system presented herein focuses on voting by site members. There is a current website run by Associated Content which does not provide for voting by site visitors. Their compensation model is also completely different. It is either tied to the number of page views an article receives or they accept assignments requested by editors/sites for a flat fee.

Demand Media is another seemingly similar site yet therein there is also no voting by site visitors. The compensation model is different too. It is like Associated Content, where flat fee payments are determined by editors.

eHow—Is another website that also does not allow for voting and has a different compensation model. Requests for articles are driven by human editors.

With Flattr—http://flattr.com/ payments come from users, not the company.

### SUMMARY OF THE INVENTION

In an exemplary embodiment of the present invention, there is disclosed a method of using a first computer to communicate over the internet to a second computer which has a web site having a blogging/ or content posting platform comprising:
providing the blogging/content posting platform with a main page and an upcoming section;
assembling together as a group the written posts received;
posting the group of received written posts to the upcoming section of the website platform on the second computer;
reviewing each post of the group of posts and rating each blog in the group for interest, relevancy, quality, etc.;
promoting a selected number of the posts with the highest rating to the main page of the platform on the computer; and
paying each submitter of the post promoted to the main page when the post is promoted to the main page.

In another exemplary embodiment of the present invention there is disclosed a system of using a first computer to communicate over the internet to a second computer which has a web site having a blogging/content posting platform comprising:
a blogging/content posting platform with a main page and an upcoming section;
assembling means for grouping together the written blog/content posts received in a fixed interval of time;
providing posting means for placing the group of received written blog posts to the upcoming section of the blogging/content platform on the second computer;
providing reviewing means for each blog/content post of the group of blog posts which rates each blog/content in the group for interest, relevancy, quality, etc.;
providing means for promoting a selected number of the blog/content posts with the highest rating to the main page of the blogging/content platform on the computer; and
providing means for paying each submitter of the blog/content post promoted to the main page when the blog/content post is promoted to the main page.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of a method of creating a web site in accordance with the principles of the invention.

### DESCRIPTION OF THE PREFERRED EMBODIMENT

The present invention provides a method and system that uses a computer to automate various functions for providing a web site. The web site is created, with a minimum expense and has a high quality content by providing a blogging platform where anyone can write and submit a blog post in a designated blogging platform where, in an embodiment, the blogging platform may consists of seven initial categories more fully identified as: Science & Technology; Business & Entrepreneurship; Sports; Environment & Social Justice; Travel, Life, & Leisure; Health & Wellness; and Home & Family.

When a person first submits their blog post to web site, it does not go to the main page. Rather, that blog post enters an “Upcoming” section of the web site. From there, site visitors who are registered voters must vote it to the home page. Each registered visitor gets three votes per day. They vote for the blog posts in the “Upcoming” blog posts that they think are the best, the most interesting, the most relevant, and of the highest quality. Each day, the top five through thirty five, where the top ten is preferred of the blogs in the Upcoming section are promoted to the main page. When a post reaches the main page, the author is then paid $20.

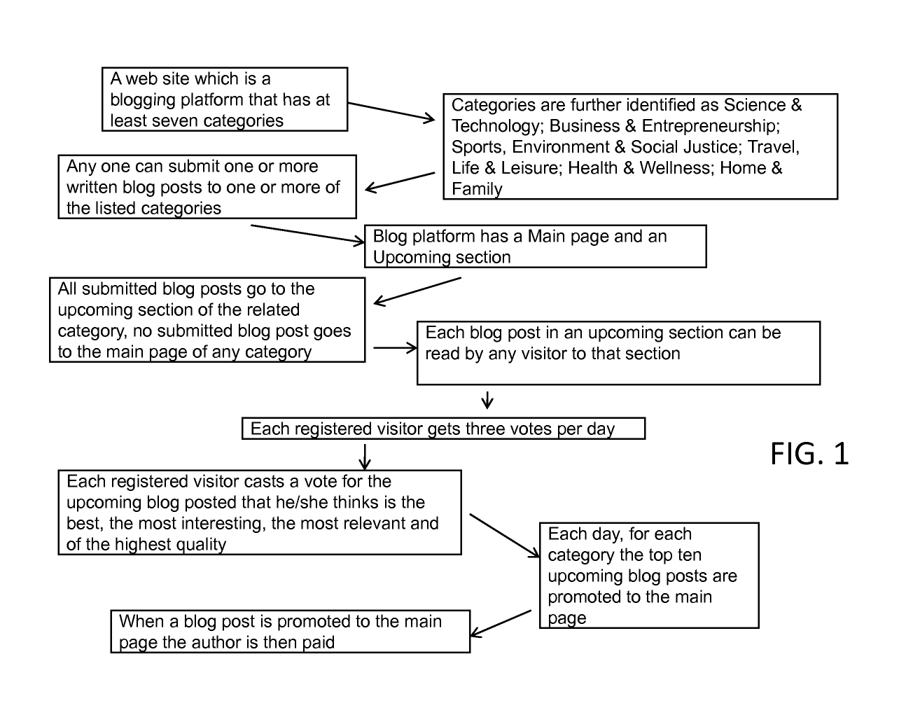

Referring to FIG. 1, there is shown a flow diagram of a method of creating a web site 10 in accordance with the principles of the invention. The web site which is a blogging platform has at least seven categories; block 12. The various categories may be further identifies as: Science & Technology; Business & entrepreneurship; Sports, Environment & Social Justice; Travel, Life, & Leisure; Health & Wellness; home & family. block 14. Any person may submit one or more written blog posts to any one or more of the listed categories of the blogging platform, block 16. The blogging platform has at least two sections, a Main page and an “Upcoming” section, block 18.

All submitted blog posts go to the Upcoming section of the relevant category, block 20. No submitted blog post goes to the main page of the web page. Each blog post which is located in a category of the Upcoming section can be read by anyone visiting the site yet voting on said content is only by a registered visitor after reading blog posts in any category, block 22. The registered visitor reads the blog posts for interest, relevancy, quality, etc., and votes for the blog post which he/she believes rates the highest, block.

Each registered visitor gets three votes per day, block 24. Each registered visitor casts a vote for the blog posted in the Upcoming section that he/she thinks is the best, the most interesting, the most relevant and of the highest quality, block 26.

Each day the some blog posts in each category, are promoted to the main page, block 28.

When a blog post is promoted to the main page the author is then paid between $10 and $100 where $20 is the preferred amount, block 30.

The method disclosed is an efficient system for several reasons. First, rather than letting a human editor decide the quality of a blog post, blog posts are instead chosen by the wisdom of the crowd. There is no editing or rewriting process. Second, with only 10, more or less of the blog posts being promoted to the home page and having been paid for, that means that 90%-95% of the content is created at no cost to the web site. Finally, the person submitting the article will promote his/her own post in the hopes of getting it voted onto the home page at their own time and expense.

A typical scenario may be as follows. A University of Iowa student decides to write and submit a blog post entitled, “Why the Iowa Hawkeyes should be ranked #1”, to the Sports section. He writes the post, submits it, and then notifies his many Facebook friends which may number 250 about the post with the hopes that they will come and vote for it. Of those many friends on Facebook, 50 may come to the site with 25 of those registering and voting for his blog post. Fifteen of them may then decide that they agree with the article so much that they are going to share it with each of their 250, more or less Facebook friends, leading to an additional 3,750 people, more or less, being notified of the post. From there, the process then repeats itself over and over.

His post then makes it to the home page of the web site and he is paid $20. Half a dozen of his original friends decide they really like the concept and are eager to create their own blog posts in hopes of getting paid. They then create an account, write a blog post about something that interests them, submits it to one of the seven categories, and the process begins all over again for each of the newly submitted articles.

These half dozen new writers are now reaching a different set of people through their own promotional efforts. Since this type of promotion and sharing will occur for all submitted/upcoming posts, it is being done at no cost to the web site and, therefore, the web site will be in a position where 90%-95% of the content is being created without cost and, in parallel with that, the vast majority of the promotions will be done with no cost to and with no effort from the web site.

With this sort of viral expansion loop initiated, it's not hard to imagine that the web site will quickly get to the point where 1,000 pages of content are being submitted daily.

Thus, not only will the web site's traffic be growing from the promotional efforts of each individual blogger, but with thousands of pages of content being created and indexed by Google and other searches engines, incoming traffic from these search engines should be significant.

In addition to the two traffic sources noted above, the web site will also benefit by people visiting the site directly to check out what will be considered to be some of the highest quality content on the Internet. Direct visits may very easily reach into the hundreds of thousands or millions per day.

The inventive web site disclosed offers the chance to do something that no one else in the world is doing. Something that may drive tens of thousands, then hundreds of thousands, then millions of pages of high quality content.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of using a first computer to communicate over the internet to a second computer which has a web site having a blogging platform comprises:
providing the blogging platform with a main page and an upcoming section;
assembling together as a group the written blog posts received;
posting the group of received written blog posts to the upcoming section of the blogging platform on the second computer;
reviewing each blog post of the group of blog posts and rating each blog in the group for interest, relevancy, quality, etc.;
promoting a selected number of the blog posts with the highest rating to the main page of the blogging platform on the computer; and
paying each submitter of the blog post promoted to the main page when the blog post is promoted to the main page.

2. The method of claim 1 wherein the main page includes at least one category.

3. The method of claim 2 wherein the at least one category includes Science & Technology; Business & entrepreneurship; Sports,
Environment & Social Justice; Travel, Life, & Leisure; Health & Wellness; or Home & Family.

4. The method of claim 3 wherein any person can submit one or more written blogs to one or more of the listed categories.

5. The method of claim 4 wherein no submitted blog post goes to the main page of any category.

6. The method of claim 5 wherein each blog post in the upcoming section can be read only by a website visitor.

7. The method of claim 6 wherein each visitor is able to register with the website.

8. The method of claim 6 wherein each registered visitor gets a predetermined number of votes to vote for the best blogs of the group of blog posts received in the fixed interval of time.

9. The method of claim 8 wherein for all categories, ten top rated blogs are promoted to the main page.

10. The method of claim 9 wherein the submitter of each blog which is promoted to the main page is paid between $10 and $100.

11. A system of using a first computer to communicate over the internet to a second computer which has a web site having a blogging platform comprising:
a blogging platform with a main page and an upcoming section;
assembling means for grouping together the written blog posts received;
providing posting means for placing the group of received written blog posts to the upcoming section of the blogging platform on the second computer;
providing reviewing means for each blog post of the group of blog posts which rates each blog in the group for interest, relevancy, quality, etc.;
providing means for promoting a selected number of the blog posts with the highest rating to the main page of the blogging platform on the computer; and
providing means for paying each submitter of the blog post promoted to the main page when the blog post is promoted to the main page.

12. The system of claim 11 wherein the main page includes at least one category.

13. The system of claim 12 wherein the at least one category includes Science & Technology; Business & entrepreneurship; Sports, Environment & Social Justice; Travel, Life, & Leisure; Health & Wellness; or Home & Family.

14. The system of claim 13 wherein any person can submit one or more written blogs to one or more of the listed categories.

15. The system of claim 14 wherein no submitted blog post goes to the main page of any category.

16. The system of claim 15 wherein each blog post in the upcoming section can be read by a registered or nonregistered visitor.

17. The system of claim 16 wherein each registered visitor gets a predetermined number of votes to vote for the best blogs of the group of blog posts received in the fixed interval of time.

18. The system of claim 17 wherein for each category, between five and thirty five top rated blogs in each category are promoted to the main page.

19. The system of claim 18 wherein the submitter of each blog which is promoted to the main page is paid between $10 and $100.
